(19) United States
(12) Patent Application Publication
(10) Pub. No.: US 2009/0119760 A1
(43) Pub. Date: May 7, 2009

(54) METHOD FOR RECONFIGURING SECURITY MECHANISM OF A WIRELESS NETWORK AND THE MOBILE NODE AND NETWORK NODE THEREOF

(75) Inventors: SHAO HSIU HUNG, HSINCHU (TW); JYH CHENG CHEN, HSINCHU (TW); CHENG KUAN HSIEH, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/262,725

(22) Filed: Oct. 31, 2008

(30) Foreign Application Priority Data
Nov. 6, 2007 (TW) 096141801

(51) Int. Cl. H04L 9/32

(52) U.S. Cl. 726/6

(57) ABSTRACT

A method for reconfiguring the security mechanism of a wireless network system includes steps of: sending a packet from a network node to a mobile node; sending a negotiation packet from the mobile node to the network node according to a selected authentication protocol; the mobile node and the network node proceeding the authentication process if the received negotiation packet is valid; the mobile node and the network node generating a security association after the authentication process is completed.

### BACKGROUND OF THE INVENTION

1. Field of the Invention

The present invention relates to a security mechanism of a wireless network, and more particularly, to a method for reconfiguring a security mechanism of a wireless network.

2. Description of the Related Art

As the technology of wireless networks develops rapidly, a variety of wireless network systems are introduced based on varying demands. For example, a code division multiple access (CDMA) system is capable of covering a large scope and having the feature of high power transmission, but its transmission speed is too slow. Wireless local area network (WLAN) covers a smaller range with low power transmission, but features a high speed. In addition, it is important to satisfy compatible requirements when designing a wireless device because it is expected to have many wireless devices coexistent in a system or have many wireless systems connected to each other.

However, the major concern when a user is using a wireless device is network security. In particular, companies are aware of the risk that some information will be stolen via wireless communications or attacked by hackers. Therefore, it is commonly seen to add extra protection on data transmission and to make a security authentication at both network end and client end. The existing authentication protocols face a trade off between efficiency and security. That is, higher levels of security will require more computation time, and vice versa. Therefore, it is necessary to offer special demands for different users or to choose suitable authentication protocols when different wireless networks are switched.

### SUMMARY OF THE INVENTION

The present invention proposes a method for reconfiguring a security management mechanism of a wireless network, which comprises the steps of: a network node sending a broadcast packet to a mobile node in the same domain, wherein the broadcast packet includes a plurality of authentication protocols supported by the network node; the mobile node selecting one authentication protocol in accordance with the received broadcast packet, then sending an encrypted negotiation packet to the network node; the network node examining whether the negotiation packet is valid by communicating with an authentication server; the network node conducting an authentication process according to the authentication protocol in the protocol packet if the negotiation packet is valid; the mobile node communicating with the network node to complete the authentication process; and the mobile node and the network node generating a security association after the authentication process, wherein the security association includes an authentication key for protecting signaling packets.

The present invention proposes a security management method used at a network end, which comprises the steps of: a plurality of network nodes and edged network nodes at the network end taking their certificates from an authentication server upon startup; the network nodes and edged network nodes broadcasting the certificates to their neighboring nodes; the neighboring nodes forwarding their certificates to the network nodes and edged network nodes; and the network nodes and edged network nodes establishing a security association with their neighboring nodes.

A mobile node of a wireless network with a security management mechanism comprises a client-end platform controller, a client-end platform controller notifier, a security parameter recorder, a client-end security protection unit, a plurality of client-end authentication modules, a client-end platform registrar and a protocol selector. The client-end platform controller notifier is configured to monitor packet transmission and to transmit received packets into the client-end platform controller. The security parameter recorder is configured to record a pre-shared key and an authentication key generated during an authentication process. The client-end security protection unit is connected to the client-end platform controller, the client-end platform controller notifier, and the security parameter recorder. The client-end security protection unit verifies packets passing the client-end platform controller and the client-end platform controller notifier in accordance with data in the security parameter recorder. The plurality of client-end authentication modules each corresponds to an authentication protocol, and each is connected to the security parameter recorder and client-end platform controller. The client-end platform registrar is connected to the client-end platform controller and the client-end authentication modules for defining a template of each authentication protocol and receiving a registration application of each authentication protocol. The protocol selector is connected to the client-end platform controller for selecting an authentication protocol to determine the security management mechanism.

A network node of a wireless network with a security management mechanism comprises a platform controller, a platform controller notifier, a security parameter database, a security protection unit, a plurality of authentication modules, a platform registrar and a mobile node database. The platform controller notifier is configured to monitor packet transmission and to transmit received packets to the platform controller. The security parameter database is configured to record common secure information with neighboring nodes. The security protection unit is connected to the platform controller, the platform controller notifier and the security parameter database, wherein the security protection unit verifies packets passing the platform controller and the platform controller notifier in accordance with data in the security parameter database. Each of the authentication modules corresponds to an authentication protocol, and is connected to the security parameter database and platform controller. The platform registrar is connected to the platform controller and the authentication modules for defining a template of each authentication protocol and for receiving a registration application of each authentication protocol. The mobile node database is connected to the platform controller and to the platform controller notifier for recording all mobile nodes in the same domain.

### BRIEF DESCRIPTION OF THE DRAWINGS

The invention will be described according to the appended drawings in which:

FIG. 1 shows an architecture of a wireless network system;

FIG. 2 shows mobile nodes of a wireless network in accordance with one embodiment of the present invention;

FIG. 3 shows network nodes in accordance with one embodiment of the present invention;

FIG. 4 shows a flow chart of a security management mechanism in accordance with one embodiment of the present invention; and

FIG. 5 shows a flow chart of network-end security management in accordance with one embodiment of the present invention.

### PREFERRED EMBODIMENT OF THE PRESENT INVENTION

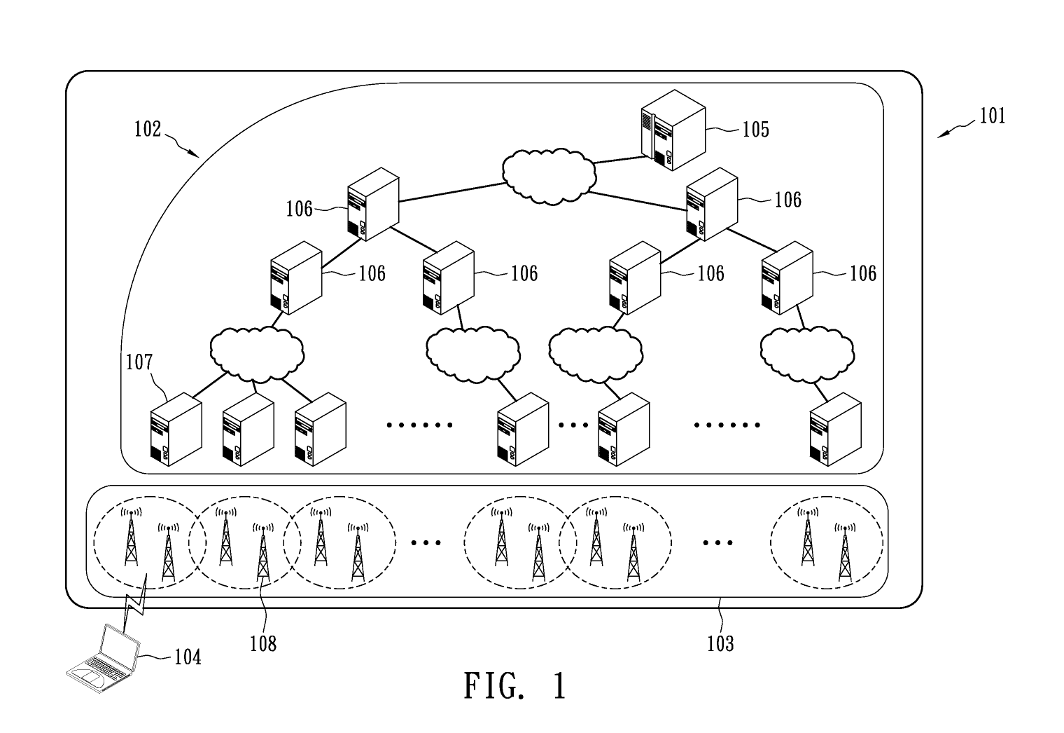

Generally, a wireless network system comprises two parts: radio access network (RAN) and core network. The RAN is used to provide hardware resources to users, such as signal channels, while the core network is primarily used to connect different RANs through wires or to bridge them to other networks such as Internet or telephone systems. FIG. 1 shows an architecture of a wireless network system 101, which includes a core network 102 and a plurality of RANs 103. The core network 102 is formed in a tree structure manner, including an authentication server 105, a plurality of network nodes 106 connected to each other or connected to the authentication server 105, and a plurality of edged network nodes 107 connected to the network nodes. The RANs 103 include a plurality of base stations 108, and each corresponds to an edged network node 107 for acting as a medium between a mobile node 104 and the core network 102.

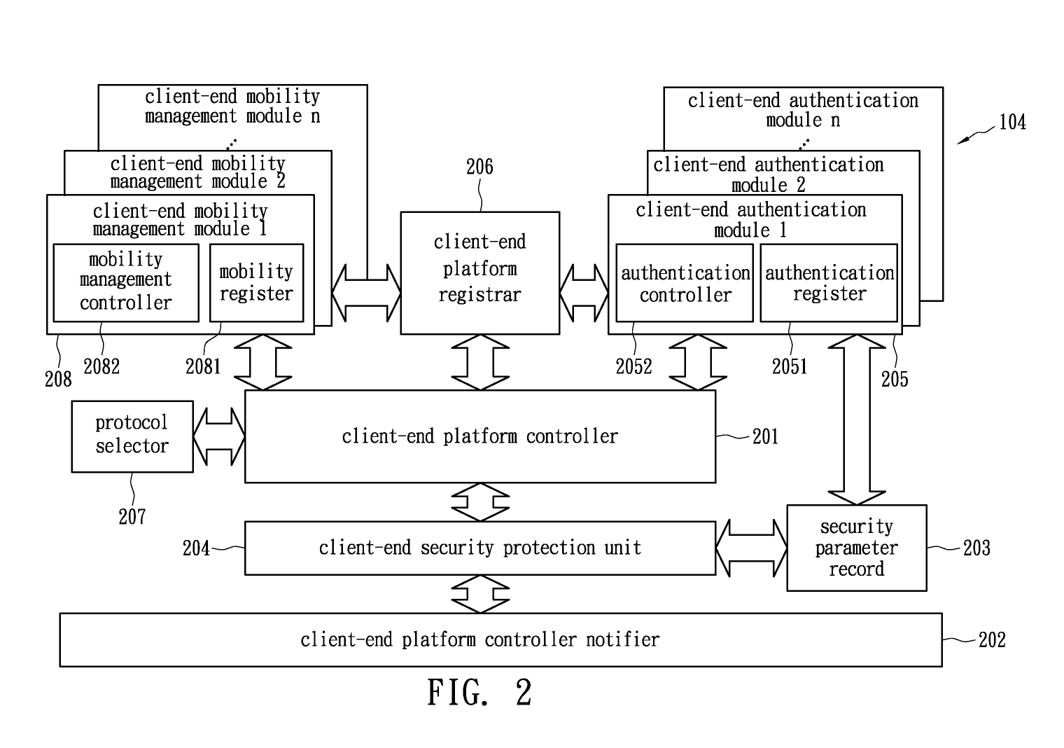

FIG. 2 shows mobile nodes of a wireless network in accordance with one embodiment of the present invention. The mobile node 104 includes a client-end platform controller 201, a client-end platform controller notifier 202, a security parameter recorder 203, a client-end security protection unit 204, a plurality of client-end authentication modules 205, a client-end platform registrar 206 and a protocol selector 207. The client-end platform controller 201 is used to control the mobile node 104 and is responsible for managing the mobile nodes and other components. The client-end platform controller notifier 202 is used to monitor the mobile node 104 and to transmit packets received by the mobile node 104 to the client-end platform controller 201. The security parameter recorder 203 is used to record secret information commonly owned by the mobile node 104 and the new domain, including a pre-shared key and an authentication key generated during the authentication process, and adds electronic signatures to packets intended to be sent out. The client-end security protection unit 204 is disposed between the client-end platform controller 201 and the client-end platform controller notifier 202, and is connected to the security parameter recorder 203. The client-end security protection unit 204 verifies packets passing the client-end platform controller 201 and the client-end platform controller notifier 202 in accordance with data in the security parameter recorder 203. Each of the client-end authentication modules 205 corresponds to a set of authentication protocols, being connected to the security parameter recorder 203 and client-end platform controller 201, and further includes an authentication registrar 2051 and an authentication controller 2052. The authentication registrar 2051 is used to register at the client-end platform registrar 206, and to establish communication channels to the client-end platform controller 201 and the security parameter recorder 203. The authentication controller 2052 is used to control the operation of the client-end authentication modules 205, and to communicate with the client-end platform controller 201 and security parameter recorder 203. The client-end platform registrar 206 is connected to the client-end platform controller 201 and client-end authentication modules 205 for defining the template of each authentication protocol and for receiving register applications from each authentication protocol. The protocol selector 207 is connected to the client-end platform controller 201 and is configured to select an authentication protocol for a user in accordance with the authentication protocols supported by the mobile node 104 and the domain. As such, the security management mechanism of the mobile node 104 and the domain is determined.

The present mobile nodes of the wireless network can be reconfigured for different mobile management mechanisms. That is, when a user holds a mobile node 104 into a new domain, he or she can reconfigure the mobile management mechanism between the mobile node 104 and the edged network nodes 107, where each mobile management mechanism has one mobile management protocol. The mobile node 104 shown in FIG. 2 further comprises a plurality of the client-end mobile management modules 208. Each of the client-end mobile management modules 208 corresponds to a set of mobile management protocols, and is connected to the client-end platform registrar 206 and client-end platform controller 201, respectively. The protocol selector 207 further provides the user with a mobile management protocol supported by the mobile node 104 and the domain, so as to choose a mobile management protocol, which is used to determine the mobile management mechanism of the domain. The plurality of client-end mobile management modules 208 includes a mobile management registrar 2081 and a mobile management controller 2082. The mobile management registrar 2081 is used to register at the client-end platform registrar 206, and to establish a communication channel to the client-end platform controller 201. The mobile management controller 2082 is used to control the operation of the client-end mobile management module 208 and to communicate with the client-end platform controller 201.

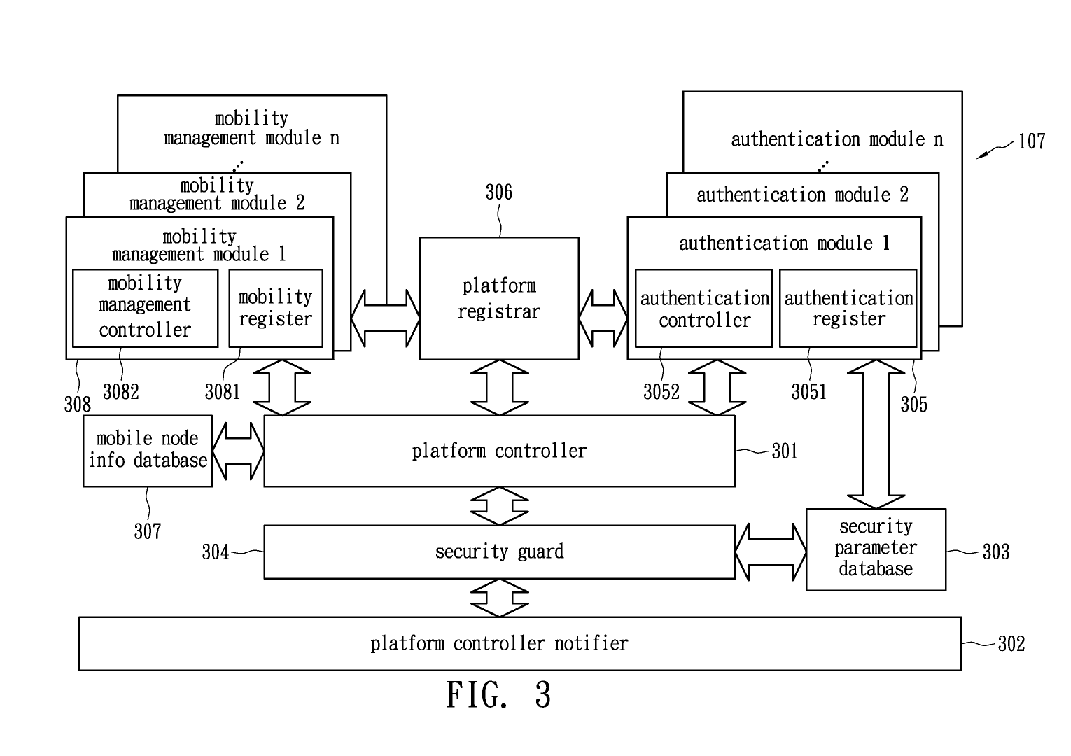

FIG. 3 shows network nodes in accordance with one embodiment of the present invention. The network node 107 includes a platform controller 301, a platform controller notifier 302, a security parameter database 303, a security protection unit 304, a plurality of authentication module 305, a platform registrar 306 and a mobile node database 307. The platform controller 301 is used to control the operation of the network nodes 107, and is responsible for managing the network node 107 and other components. The platform controller notifier 302 is used to monitor the packet transmission of the network node 107 and transmits the packets received by the mobile node 104 to the platform controller 301. The security parameter database 303 is used to record secret information commonly owned with all neighboring nodes of the mobile node 107. If the mobile node 107 is an edged network node, the security parameter database 303 further records the common secret information of the mobile node 104 and the new domain, which includes a pre-shared key of the mobile node 104 and the new domain, and an authentication key generated during the authentication process. The security protection unit 304 is disposed between the platform controller 301 and the platform controller notifier 302, and is connected to the security parameter database 303. The security protection unit 304 verifies packets passing through the platform controller 301 and the platform controller notifier 302 in accordance with the data stored in the security parameter database 303, and adds electronic signatures on the packets intended to be sent out. Each of the authentication modules 305 corresponds to a set of authentication protocols, and are connected to the security parameter database 303 and the platform controller 301. In addition, the authentication modules 305 include an authentication registrar 3051 and an authentication controller 3052. The authentication registrar 3051 is used to register at the platform registrar 306, and establishes two communication channels to the platform controller 301 and the security parameter database 303. The authentication controller 3052 is used to control the operation of the authentication modules 305, and communicates with the platform controller 301 and the security parameter database 303. The platform registrar 306 is connected to the platform controller 301 and authentication modules 305 for defining the template of each authentication protocol and for receiving register applications from each authentication protocol. The mobile node database 307 is connected to the platform controller 301 and the platform controller notifier 302, and records all mobile nodes and related information in the new domain, which includes the network protocol address, authentication information, contact information and security management mechanism of the mobile node 104.

The present network node can be reconfigured based on different mobile management mechanisms. That is, when a user carries a mobile node 104 into a new domain, he or she can reconfigure the mobile management mechanism between the mobile node 104 and the network nodes 107 of the new domain, where each mobile management mechanism has one mobile management protocol. The network node 107 shown in FIG. 3 further comprises a plurality of the mobile management modules 308. Each of the mobile management modules 308 corresponds to a set of mobile management protocols, and is connected to the platform registrar 306 and platform controller 301, respectively. The plurality of mobile management module 308 each includes a mobile management registrar 3081 and a mobile management controller 3082. The mobile management registrar 3081 is used to register at the platform registrar 306, and to establish a communication channel to the platform controller 301. The mobile management controller 3082 is used to control the operation of the mobile management module 308 and to communicate with the platform controller 301.

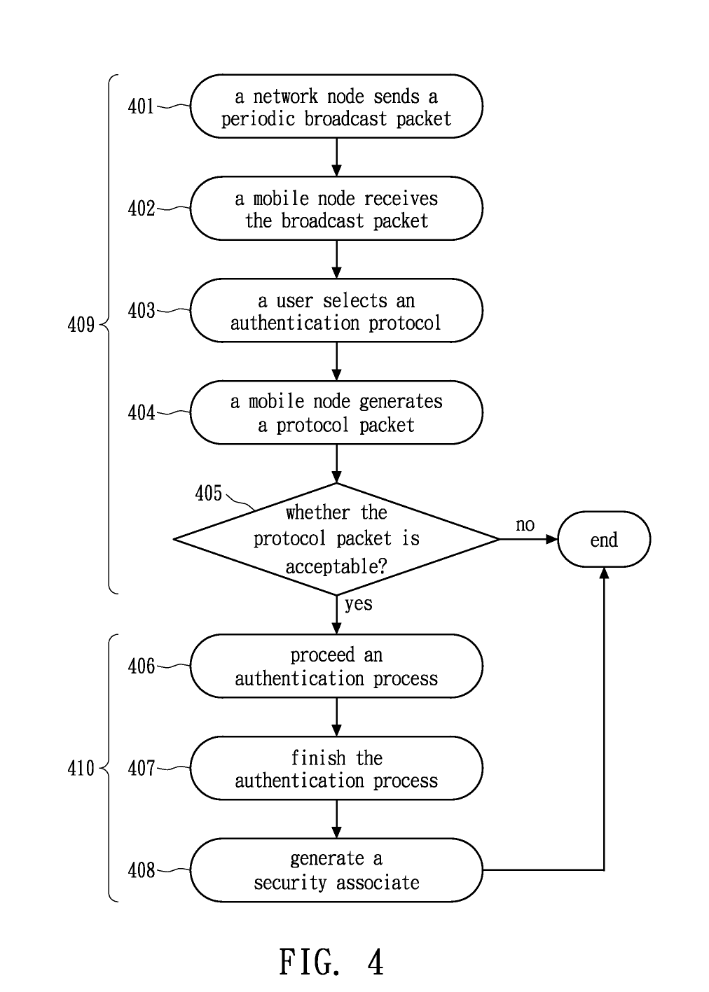

FIG. 4 shows a flow chart of security management mechanism in accordance with one embodiment of the present invention. The method can be separated into a negotiation step 409 and an authentication step 410, where the negotiation step 409 includes steps 401 to 405, while the authentication step includes steps 406 to 408. When a user holds a mobile node 104 supporting a plurality of authentication protocols into a wireless system 101, the network node 107 sends periodic broadcast packets which support authentication protocols of the network nodes to the mobile node 104, as shown in Step 401. In Step 402, after the mobile node 104 receives the broadcast packets, the client-end security protection unit 204 of the mobile node 104 transmits the packets to the client-end platform controller 201, while the user can view at least one authentication protocol commonly supported by the mobile node 104 and network node 107 through the protocol selector 207. In addition, an algorithm can be used to calculate and select the most suitable authentication protocol, e.g., directly selecting the safest authentication protocol to protect users. In Step 403, the user selects one authentication protocol to decide a new security management protocol which will be commonly used in the mobile node 104 and the network node 107. In Step 404, the mobile node 104 generates a packet from the client-end platform controller 201 in accordance with the new decided authentication protocol. The packet includes the identity of the mobile node 104 and the decided authentication protocol, and is transmitted to the client-end security protection unit 204. After the client-end security protection unit 204 receives the negotiation packet, a pre-shared key is obtained from the security parameter recorder 203, is encrypted and then sent to the network node 107. In Step 405, the security protection unit 304 of the network node 107 representing the mobile node 104 captures the pre-shared key from the security parameter database 303 to conduct a decryption. If the security parameter database 303 does not have the pre-selected key, the network node 107 communicates with the authentication server 105 to determine the validity of the received negotiation packets. If it is invalid, the negotiation process is terminated. Otherwise, the mobile node database 307 of the network node 107 records the address of the mobile node 104 and selected authentication protocol, terminating the negotiation process and starting the authentication process by sending an authentication packet to the mobile node 104 in accordance with the authentication protocol, as shown in Step 406. In Step 407, the mobile node 104 and the network node 107 receive and transmit authentication packets based on the selected authentication protocol through the plurality of the client-end authentication modules 205 and authentication modules 305, respectively. In Step 408, after the authentication process is done, the mobile node and network node generate a security association which includes an authentication key to protect the signaling packets to be transmitted later.

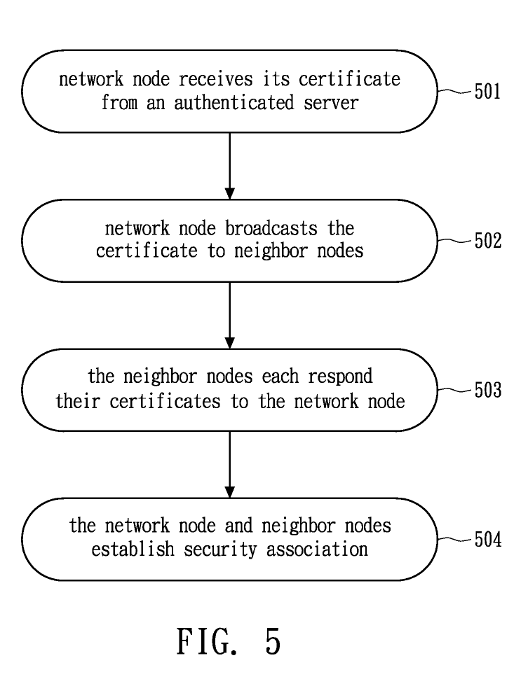

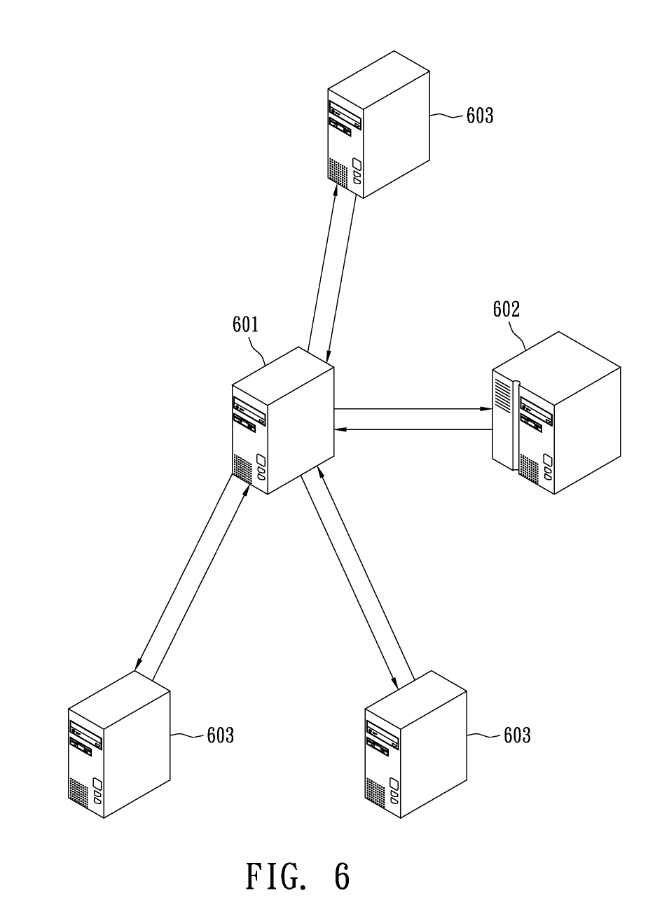

FIG. 5 shows a flow chart of network-end security management in accordance with one embodiment of the present invention, and FIG. 6 shows its corresponding architecture. In Step 501, after a network node 601 starts, a certificate of the network node 601 is obtained from an authentication server 602. In Step 502, the network node 601 broadcasts the certificate to its neighboring nodes 603. In Step 503, the neighboring nodes 603 forward their certificates to the network node 601. In Step 504, the network node 601 establishes a set of security associations with the neighboring nodes 603 based on the transmitted certificate and received certificate. When communication between two nodes has been established, security association is conducted, a transmitter of the two nodes generates a message authentication code based on the security association on the signaling packets, and a receiver of the two nodes can use the security association and the message authentication code to confirm the completeness of the packet transmission.

The above-described embodiments of the present invention are intended to be illustrative only. Numerous alternative embodiments may be devised by persons skilled in the art without departing from the scope of the following claims.

What is claimed is:

1. A method for reconfiguring security management mechanism of a wireless network, comprising the steps of:
a network node sending a broadcast packet to a mobile node in the same domain, wherein the broadcast packet includes a plurality of authentication protocols supported by the network node;
the mobile node selecting one authentication protocol in accordance with the received broadcast packet, and sending an encrypted negotiation packet to the network node;
the network node examining whether the negotiation packet is valid by communicating with an authentication server;
the network node conducting an authentication process according to the authentication protocol in the protocol packet if the negotiation packet is valid;
the mobile node communicating with the network node to complete the authentication process; and
the mobile node and the network node generating a security association after the authentication process, wherein the security association includes an authentication key for protecting signaling packets.

2. The method of claim 1, further comprising the step of:
the mobile node selecting one mobile management protocol in accordance with the received broadcasted packet, wherein the broadcast packet includes a plurality of mobile management protocols supported by the network node.

3. The method of claim 1, wherein the examining step is based on a pre-shared key.

4. The method of claim 1, wherein the broadcast packet is transmitted periodically.

5. A security management method used at a network end, comprising the steps of:
a plurality of network nodes and edged network nodes at the network end taking their certificates from an authentication server upon startup;
the network nodes and edged network nodes broadcasting the certificates to their neighboring nodes;
the neighboring nodes forwarding their certificates to the network nodes and edged network nodes; and
the network nodes and edged network nodes establishing a security association with their neighboring nodes.

6. The security management method of claim 5, wherein the establishing step comprises:
a transmitter generating a message authentication code in the signaling packet in accordance with the security association; and
a receiver confirming the completeness of transmitted packets in accordance with the security association and message authentication code.

7. A mobile node of a wireless network with a security management mechanism, comprising:
a client-end platform controller;
a client-end platform controller notifier configured to monitor packet transmission and to transmit received packets to the client-end platform controller;
a security parameter recorder configured to record a pre-shared key and an authentication key generated during an authentication process; and
a client-end security protection unit connected to the client-end platform controller, the client-end platform controller notifier and the security parameter recorder, wherein the client-end security protection unit verifies packets passing the client-end platform controller and client-end platform controller notifier in accordance with data in the security parameter recorder;
a plurality of client-end authentication modules each corresponding to a set of authentication protocols, and connected to the security parameter recorder and client-end platform controller;
a client-end platform registrar connected to the client-end platform controller and the client-end authentication modules for defining a template of each authentication protocol and receiving a registration application of each authentication protocol; and
a protocol selector connected to the client-end platform controller for selecting an authentication protocol to determine the security management mechanism.

8. The mobile node of claim 7, further comprising a plurality of client-end mobile management modules, wherein each client-end mobile management module corresponds to a mobile management protocol, and is connected to the client-end platform registrar and client-end platform controller.

9. The mobile node of claim 8, wherein the protocol selector further selects a mobile management protocol to determine the mobile management mechanism.

10. The mobile node of claim 7, wherein the client-end authentication modules include an authentication registrar and an authentication controller, wherein the authentication registrar is used to register at the client-end platform registrar and to establish two communication channels to the client-end platform controller and security parameter recorder, and the authentication controller is configured to control the client-end authentication modules and to communicate with the client-end platform controller and the security parameter recorder.

11. The mobile node of claim 8, wherein the client-end mobile management modules comprise a mobile management registrar and a mobile management controller, wherein the mobile management registrar is used to register at the client-end platform registrar and to establish one communication channel to the client-end platform controller, the mobile management controller is configured to control the client-end mobile management module and to communicate with the client-end platform controller.

12. The mobile node of claim 7, wherein the security parameter recorder adds an electronic signature on output packets from the mobile node.

13. A network node of a wireless network with a security management mechanism, comprising:
a platform controller;
a platform controller notifier configured to monitor packet transmission and to transmit received packets to the platform controller;
a security parameter database configured to record common secret information with neighboring nodes; and
a security protection unit connected to the platform controller, the platform controller notifier and the security parameter database, wherein the security protection unit verifies packets passing the platform controller and platform controller notifier in accordance with data in the security parameter database;
a plurality of authentication modules each corresponding to an authentication protocol and connected to the security parameter database and platform controller;
a platform registrar connected to the platform controller and the authentication modules for defining a template of each authentication protocol and for receiving a registration application of each authentication protocol; and
a mobile node database connected to the platform controller and the platform controller notifier for recording all mobile nodes in the same domain.

14. The network node of claim 13, wherein the security parameter database records a pre-shared key and an authentication key generated during the authentication process if the network node is an edged network node.

15. The network node of claim 13, wherein the data in the security parameter database includes a network protocol address, authentication information, contact information and security management mechanism of the mobile node.

16. The network node of claim 13, further comprising a plurality of mobile management modules, each corresponding to a mobile management protocol and connected to the platform registrar and platform controller.

17. The network node of claim 13, wherein each of the authentication modules includes an authentication registrar and authentication controller, wherein the authentication registrar is used to register at the platform registrar and to establish two communication channels to the platform controller and security parameter database, and the authentication controller is configured to control the authentication modules and to communicate with the platform controller and the security parameter database.

18. The network node of claim 16, wherein the mobile management modules each comprise a mobile management registrar and a mobile management controller, wherein the mobile management registrar is used to register at the platform registrar and to establish one communication channel to the platform controller, and the mobile management controller is configured to control the authentication module and to communicate with the platform controller.

19. The network node of claim 16, wherein the mobile node database records mobile management mechanism that is being used or will be used.

20. The network node of claim 13, wherein the security protection unit adds an electronic signature on output packets from the network node.
